(19) United States
(12) Patent Application Publication
(10) Pub. No.: US 2006/0162524 A1
(43) Pub. Date: Jul. 27, 2006

(54) Paper cutter

(76) Inventors: Hideyuki Suzuki, Tokyo (JP); Masayuki Kato, Tokyo (JP)

Correspondence Address: Michael S. Leonard;Everest Intellectual Property Law Group, P.O. Box 708, Northbrook, IL, 60065, US

(21) Appl. No.: 11/335,120

(22) Filed: Jan. 19, 2006

(30) Foreign Application Priority Data
Jan. 21, 2005 (JP) 2005-014141

(51) Int. Cl. B23D 19/00; B26D 1/18

(52) U.S. Cl. 83/485; 83/614; 83/478

(57) ABSTRACT

The invention provides a paper cutter capable of preventing deflection of the rotary circular blade at a cutting position and height and weight thereof is reduced, wherein a fixed blade is provided at an edge of a paper mounting base and a guide rail is disposed on a rear surface of the fixed blade, a slider is disposed slidably on the guide rail and a rotary blade holder having a rotary circular blade and an arm are attached to the slider, the arm is disposed striding over the fixed blade and a paper pressing plate pressing portion for pressing the paper pressing plate disposed such that it is capable of approaching/separating the fixed blade is attached, the paper pressing plate pressing portion is provided with a roller holder for supporting a pressing roller rotatably, and a position in which the paper pressing plate of the pressing roller is pressed is disposed before a cutting position.

### BACKGROUND OF THE INVENTION

1. Field of the Invention

The present invention relates to a paper cutter for cutting a paper sheet loaded on a paper mounting base by sliding a rotary circular blade along a fixed blade manually.

2. Description of the Related Art

Conventionally, a paper cutter which cuts a paper sheet mounted on a paper mounting base by sliding a rotary circular blade along a fixed blade by hand has been used. In such a paper cutter, its rotary blade holder rotatably supporting the rotary circular blade is constructed to slide along a guide rail disposed above the paper mounting base.

As a conventionally used paper cutter, there is a paper cutter invented by an applicant of the present invention (see Japanese Patent Application Laid-Open (JP-A) No. 5-245794). FIG. 9 shows an entire perspective view of the paper cutter described in JP-A No. 5-245794. FIG. 10 shows a sectional view taken along a line X-X of FIG. 9.

As shown in FIG. 9, a rail 52 for guiding the sliding of a slider 53 is disposed on a side of an end of a paper mounting base 51. Both ends of the rail 52 are provided such that they are movable vertically by means of supporting members 54, 55 fixed on the paper mounting base 51. A paper pressing plate 56 is provided below the rail 52 such that it is movable in the vertical direction with respect to the paper mounting base 51 independently of the rail 52. A slider 53 is mounted slidably on the rail 52.

As shown in FIG. 10, the slider 53 is slidably disposed in engagement with the rail 52 such that a side surface of a rotary circular blade 57 rotatably supported by the slider 53 is in contact with a side edge of a paper pressing plate 56. A rubber 58 for protecting a blade tip of the rotary circular blade 57 is provided on the paper mounting base 51 with which a blade of the rotary circular blade 57 makes contact.

If the slider 53 is pressed, the rail 52 is descended in parallel to the paper mounting base by supporting members 54, 55 and at the same time, the paper pressing plate 56 is descended so as to nip a paper sheet to be cut between the paper pressing plate 56 and the paper mounting base 51. If the slider 53 is slid along the rail 52 with this condition, the paper sheet to be cut nipped between the paper pressing plate 56 and the paper mounting base 51 can be cut by the rotary circular blade 57.

If a pressing force applied to the slider 53 is released, the rail 52 moves upward by a drive mechanism (not shown). At this time, the paper pressing plate 56 rises in a vertical direction with respect to the paper mounting base 51 by means of a compression spring 59 until its stopper member (not shown) comes into contact with the rail 52 while guided by a guide member (not shown), so that a top surface of the paper mounting base 51 and the paper pressing plate 56 becomes parallel to each other so as to form a gap between them.

In case of a conventional paper cutter for cutting a paper sheet mounted on the paper mounting base manually, a rail needs to be provided on the paper mounting base in order to allow a slider supporting a rotary circular blade to slide. Thus, height of the paper cutter becomes high and its weight is heavier than desired.

Further, because there is a distance between a position of the rail at the time of cutting and a cutting position by the rotary circular blade, a minute deflection between the slider and the rail in a direction perpendicular to a sliding direction of the slider becomes an enlarged deflection at the cutting position of the rotary circular blade, thereby possibly leading to cutting deflection.

### SUMMARY OF THE INVENTION

An object of the present invention is to provided a paper cutter capable of preventing deflection of a rotary circular blade at a cutting position despite its simple structure, in which height thereof is prevented from being high and weight thereof is reduced.

The object of the preset invention can be achieved by respective aspects of the present invention mentioned hereinafter.

That is, the present invention comprises: a paper mounting base; a long linear fixed blade disposed at an end of the paper mounting base with its front surface substantially flush with a top surface of the paper mounting base and its rear surface being provided with a guide rail; a slider which slides along the guide rail; a rotary circular blade which slides in contact with the fixed blade with its rotation shaft disposed above a front surface of the fixed blade; a rotary blade holder which rotatably supports the rotary circular blade; an arm attached to the slider such that it strides over a cutting edge of the fixed blade; and a manual operating portion provided on the arm, wherein the rotary blade holder is attached to the slider such that it strides over the cutting edge of the fixed blade and by pressing the manual operating portion in a horizontal direction, the rotary circular blade is slid along the fixed blade in contact with the fixed blade.

A structure in which the paper pressing plate is pressed toward the fixed blade by the paper pressing plate pressing portion provided on the arm is another feature.

Further, still another feature is that a structure of the paper pressing plate pressing portion is restricted.

A further feature is that a structure of a manual operating portion which slides the rotary circular blade in a cutting direction is restricted.

A further feature is that an inclined portion for guiding a cut piece outward is formed in an arm.

A further feature is that an auxiliary paper mounting base which can be accommodated in the paper mounting base is provided and a dust tray is formed below a guide rail.

A still further feature is that a structure of a guide piece for restricting a position of an edge of one side of a paper sheet to be cut is specified.

A still further feature is a returning mechanism of the slider.

A yet still further feature is that scales are formed on the paper pressing plate.

Because according to the present invention, the guide rail and the cutting position by the rotary circular blade can be disposed close to each other, an influence of deflection between the slider and the guide rail upon the cutting position of the rotary circular blade can be reduced, thereby cutting with a high linearity being achieved.

Further, because the guide rail can be disposed within the paper mounting base, a main body of the paper cutter can be constructed in a thin form and weight of the paper cutter can be reduced. Thus, the present invention can provide a paper cutter convenient for carrying and capable of cutting with a high accuracy.

Further, by providing a manual operating portion on the arm, the slider and rotary blade holder can be slid by simply moving the arm nipped with the fingers in a horizontal direction, deflection or the like upon sliding can be prevented.

Further, a pressing position in which the paper pressing plate is pressed against the fixed blade by the paper pressing plate pressing portion provided on the arm may be set in the cutting direction of the rotary circular blade before a cutting position by the rotary circular blade and the fixed blade.

As a consequence, a paper sheet to be cut can be fixed by the paper pressing plate firmly and securely. Further, because the paper pressing plate is pressed at a forward side of the cutting position by the rotary circular blade and the fixed blade, the paper sheet to be cut can be cut by the rotary circular blade and the fixed blade in a condition that it is fixed securely. Consequently, the paper sheet to be cut can be prevented from deflecting during cutting operation.

The pressing member at the paper pressing plate pressing portion may be constructed as a pressing roller or a semispherical protrusion or a rotatable spherical body. As the pressing member, a variety of structures may be adopted as long as no sliding resistance is generated between a contact portion of the pressing member and the paper pressing plate when the slider is slid along the guide rail.

Further, a leaf spring may be used to apply an urging force to the pressing roller toward the paper pressing plate. Consequently, a contact area between the paper pressing plate and the paper sheet to be cut can be constructed to be wide, thereby more securely preventing the paper from deflecting.

By forming a grip on the paper pressing plate pressing portion, a shape of the grip may be easily formed in a shape easy to be manually operated. If the grip, the slider and the rotary blade holder can be constructed separately, so that freedom of design in each of them can be improved.

By forming an inclined portion for discharging a cut piece outward, for example, downward, in part of a lower cover mounted on the arm, the cut piece can be discharged smoothly from a cutting position. This inclined portion may be formed in other part than the lower cover depending on a shape of the lower cover, in the upper cover mounted on the arm, or in the arm itself. As a consequence, the paper sheet to be cut is prevented from being cut distortedly or its cutting position can be securely prevented from deflecting. Because the inclined portion is formed in the lower cover, the shape of the inclined portion may be formed as desired.

Since the auxiliary paper mounting base is provided on the paper mounting base in order to cut a large paper sheet, the large paper sheet can be cut using the auxiliary paper mounting base and the paper mounting base. When a paper sheet which is mounted on the paper mounting base is cut or the paper cutter is carried, the auxiliary paper mounting base may be accommodated within the paper mounting base.

As a structure for mounting the auxiliary paper mounting base on the paper mounting base, for example, if an end portion of the auxiliary paper mounting base is supported rotatably by the paper mounting base so that the auxiliary paper mounting base can be developed by rotation, the auxiliary paper mounting base can be made to function together with the paper mounting base. If the auxiliary paper mounting base is rotated for storage, it may be accommodated within the paper mounting base. Alternatively, it may be formed in a form of a drawer and disposed to the paper mounting base. When the auxiliary paper mounting base is accommodated in the paper mounting base, it is permissible to employ an appropriate engaging means for keeping the auxiliary paper mounting base from coming out from the paper mounting base when not required.

By providing a dust tray below the guide rail, scattering of cut pieces can be prevented. Further, by curving an inside of the dust tray, cut pieces deposited within the dust tray can be thrown out easily.

Because a guide direction of a guide piece acting as a criterion for one side of the paper sheet to be cut can be adjusted, the direction of the guide piece can be adjusted to a cutting angle desired by a user. Particularly, if a user wants to cut a paper sheet with foursquare cut sides, the paper can be always cut in a direction perpendicular to a guide direction specified by the same guide piece by adjusting the inclination of the guide piece finely.

As a structure for adjusting the guide piece, for example, if three mounting holes are formed in a length direction of the guide piece, the two holes of them except the mounting hole in a center may be formed as elongated holes. In this case, as for an adjustment method for an angular position of the guide piece, screws or the like for fixing the guide piece to the paper mounting base through the mounting holes are loosened and then the guide piece is rotated around the mounting hole in the center. By tightening the screws after the angular position of the guide piece is adjusted to a desired angular position, the guide piece may be adjusted to a desired angular position.

The rotary blade holder, the arm and the slider may be returned to their initial positions by using a constant load spring. As a consequence, after cutting by the rotary circular blade and the fixed blade ends by sliding the manual operating portion by pressing horizontally, if the manual operating portion is released, the rotary circular blade, the arm and the slider may be automatically returned to their initial positions.

Further, since the constant load spring is employed, the rotary blade holder, the arm and the slider are pulled by a constant load when they are returned to the initial positions. As a consequence, even if cutting width of a paper cutter is extended, they can be always brought back at a predetermined speed. Additionally, a pressing force for sliding the slider and the like when cutting a paper becomes constant as a small value.

The paper pressing plate may be formed of a transparent plate and scales parallel to the fixed blade may be formed on a front surface or a rear surface of the paper pressing plate. With such a structure, for example when a print paper on which photograph is developed or printed is used as a paper sheet to be cut, its margin width can be adjusted by seeing the scale on the paper pressing plate through the transparent paper pressing plate. That is, by setting an edge of a photograph along a scale line, a width of the margin can be adjusted depending to a length from that setting position up to the fixed blade.

### BRIEF DESCRIPTION OF THE DRAWINGS

FIG. 1 is an entire perspective view of a paper cutter of an embodiment;

FIG. 2 is a disassembled diagram showing an entire view of the paper cutter of the embodiment;

FIG. 3 is a perspective view of the paper cutter of the embodiment with a supporting member on one side omitted;

FIG. 4 is a perspective view of the paper cutter of the embodiment with a supporting member on the other side omitted;

FIG. 5 is a perspective view of major portions indicating surroundings of a cutting portion relating to a rotary circular blade and a fixed blade according to the embodiment;

FIG. 6 is an enlarged perspective view of major portions indicating surroundings of a cutting portion relating to the rotary circular blade and a fixed blade according to the embodiment;

FIG. 7 is a perspective view of major portions indicating a relation between a paper pressing plate and a paper pressing plate pressing portion of the embodiment;

FIG. 8 is a diagram for explaining operation of an auxiliary paper mounting base according to the embodiment;

FIG. 9 is an entire perspective view of a paper cutter of a conventional art; and

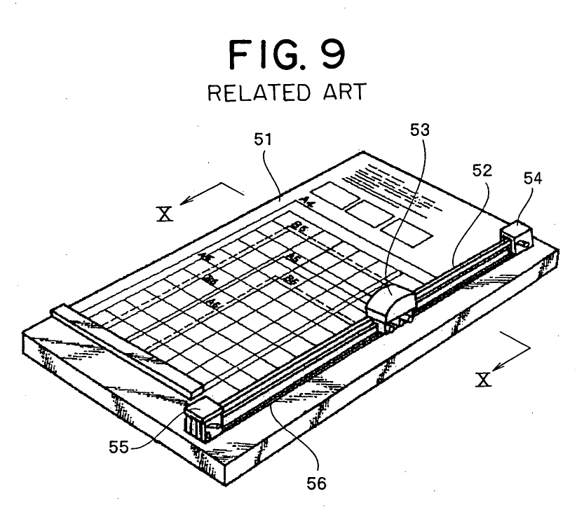

FIG. 10 is a sectional view taken along the line X-X of FIG. 9.

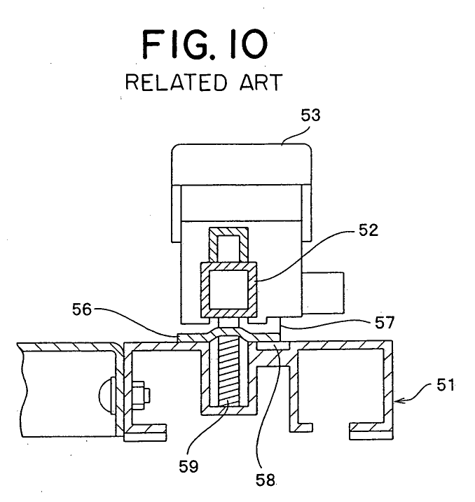

### DETAILED DESCRIPTION OF THE PREFERRED EMBODIMENTS

The preferred embodiments of the present invention will be described specifically with reference to accompanying drawings. In the meantime, the present invention is not restricted to embodiments described below and may be modified in various ways.

### Embodiments

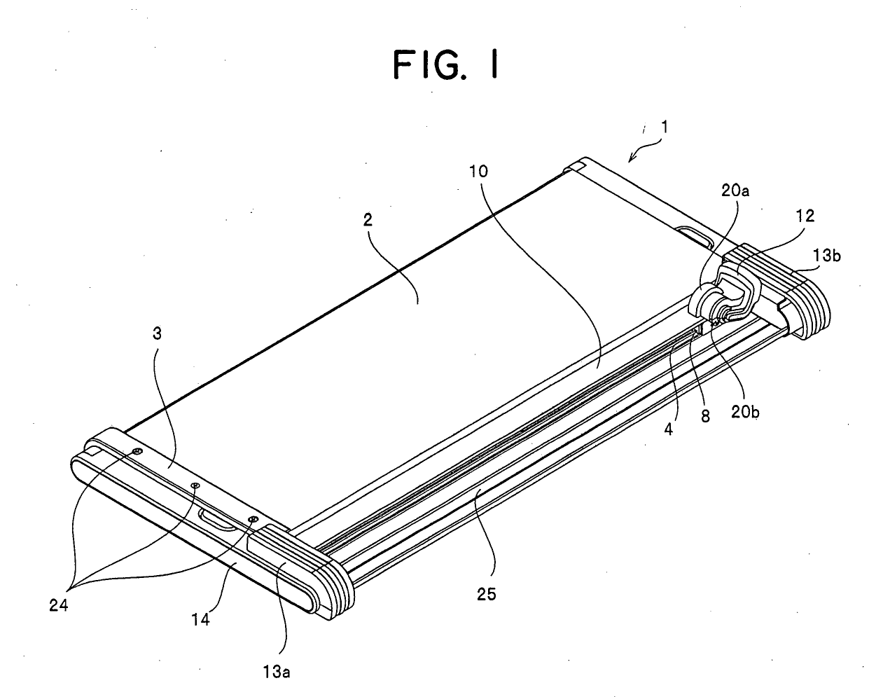

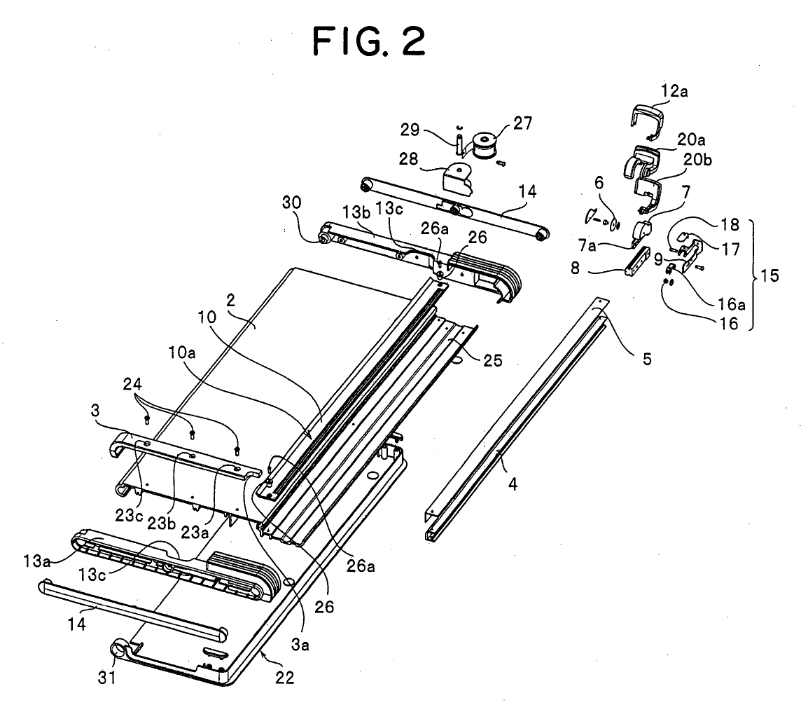

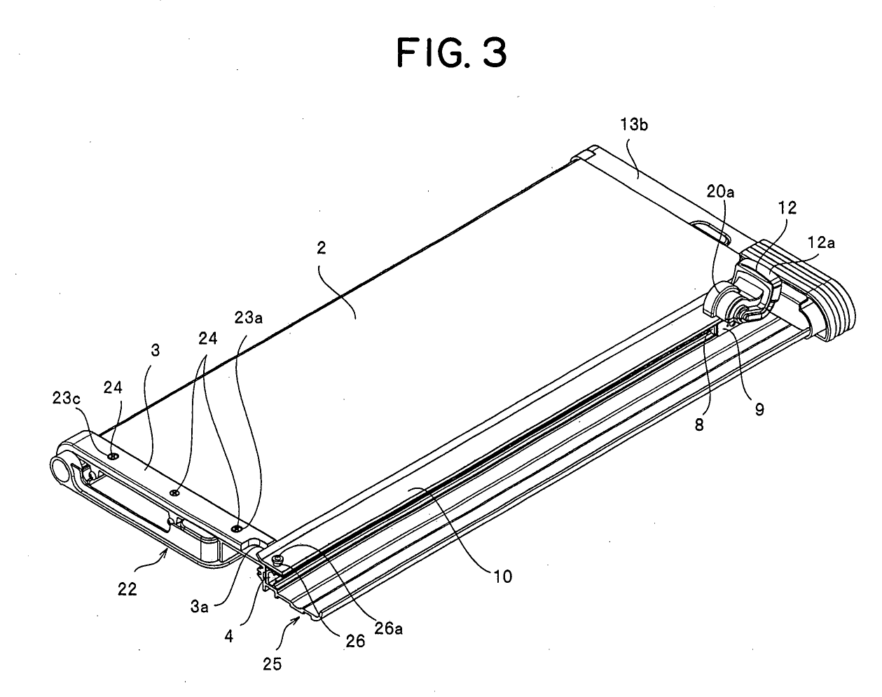

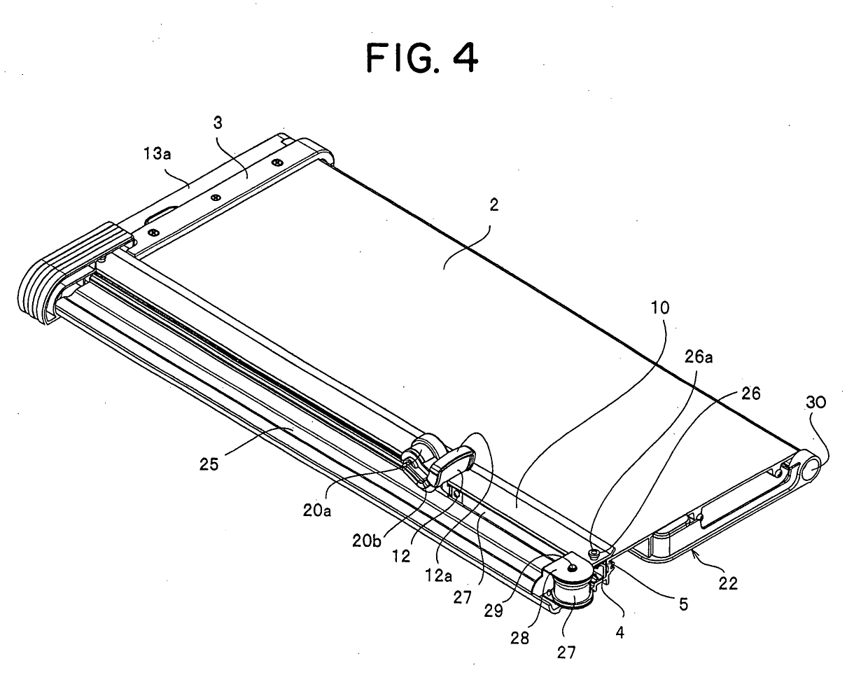

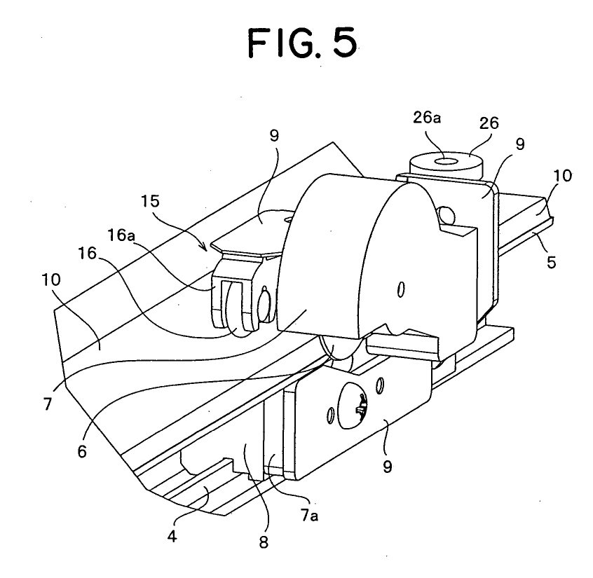

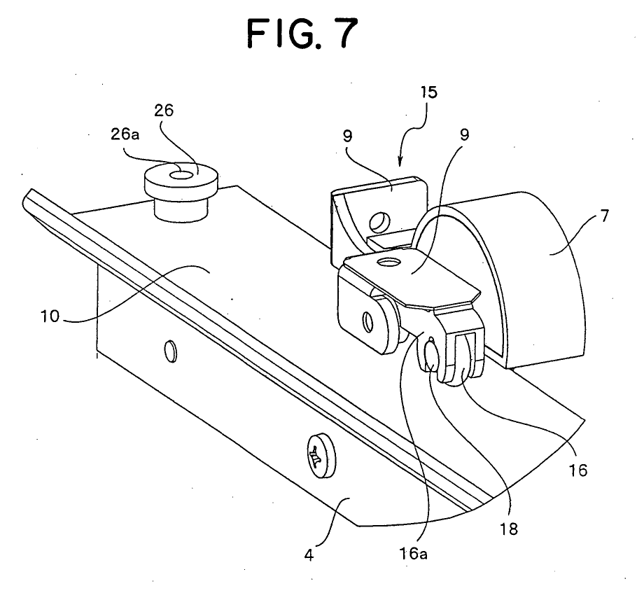

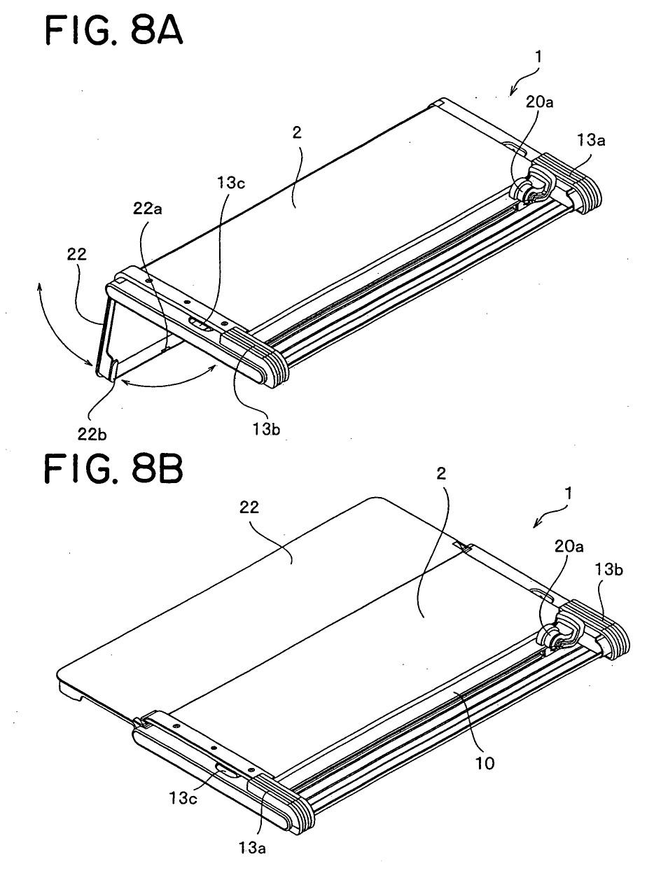

FIG. 1 shows an entire perspective view of a paper cutter 1 of the present invention, FIG. 2 is an entire structure drawing showing disassembled major components of the paper cutter 1, FIGS. 3 and 4 show a perspective view of the paper cutter 1 with one end portion omitted, and FIGS. 5 to 7 are a perspective view of major portions of the paper pressing plate pressing portion seen from different angles and FIG. 8 is a diagram for explaining expansion operation of an auxiliary paper mounting base.

As shown in FIG. 1, a long fixed blade 5 is provided at an end portion of a paper mounting base 2 of the paper cutter 1 with its front surface substantially flush with a top surface of the paper mounting base 2, its rear surface being attached with a guide rail 4, and a cutting edge thereof being directed toward the end portion of the paper mounting base 2. A paper pressing plate 10 is disposed on a front surface side of the fixed blade 5. At both ends of the paper pressing plate 10, there is provided elongated holes which are long in a length direction and whose width are substantially equal to or slightly smaller than a diameter of a collared member 26 with a brim. The paper pressing plate 10 is fixed with a play to the paper mounting base 2 at its both end portions through the collared member 26 with the brim by screws 26a. The collared member 26 with the brim has an end portion in a collar shape and an inside thereof is tapped.

By raising the paper pressing plate 10 in a direction of the brim of the collared member 26 with the brim, a gap can be formed between the paper pressing plate 10 and the paper mounting base 2. An edge on an opposite side to the fixed blade 5 of the paper pressing plate 10 is formed into a slope such that an insertion hole is opened in order to guide a paper sheet to be cut mounted on the paper mounting base 2 to be inserted easily. As shown in FIG. 2, the paper pressing plate 10 is formed of a transparent plate and a scale 10a parallel to a cutting line of the fixed blade 5 is formed on a front surface or a rear surface of the paper pressing plate 10.

In the indicated example, the scale 10a is shown only in FIG. 2 and representation of the scale 10a is omitted in the paper pressing plate of other Figures. By setting an edge of a photograph on a developing paper of photography on a line of the scale 10a formed on the paper pressing plate 10, width of a margin to be formed around the photograph can be adjusted arbitrarily. That is, by cutting the developing paper on which the photograph is printed at a position in which the edge of the photograph is apart from the cutting line of the fixed blade 5 by a predetermined distance, the width of the margin around the photograph can be formed corresponding to a predetermined distance from the cutting line of the fixed blade 5.

The supporting members 13a, 13b are disposed on both side edges of the paper mounting base 2 so as to be constructed as a stopper for preventing the paper pressing plate pressing portion 15 and the like sliding along the guide rail 4 from loosing out. An end surface of each supporting member 13a, 13b is covered with a cover 14. A guide piece 3 for restricting one side position of a paper sheet to be cut is fixed on a side edge of the paper mounting base 2 with screws 24.

Respective components of the paper cutter 1 will be described mainly with reference to FIG. 2. A concave portion 3a is formed in an end of the guide piece 3. Of holes 23a-23c formed in the guide piece 3 and in which the screw 24 are to be inserted, the hole 23a and the hole 23c are formed as elongated holes extending in a width direction of the guide piece 3. If the screws 24 are slackened and the concave portion 3a indicated in FIG. 3 is pressed, the guide piece 3 can rotate around the screw 24 inserted in the hole 23b so that a guide direction of the guide piece 3 can be adjusted. After the guide direction of the guide piece 3 is adjusted, the guide piece 3 can be fixed in the adjusted guide direction by tightening the respective screws 24.

The fixed blade 5 has a L-shaped sectional shape and is fixed to the paper mounting base 2 with screws or the like (not shown) so that the cutting edge of the fixed blade 5 is directed toward the end portion of the paper mounting base 2 and a top surface of a L-shaped structure is substantially flush with a top surface of the paper mounting base 2. A substantially U-shaped guide rail 4 is fixed to a rear surface of the fixed blade 5 with screws or the like (not shown) so that a sliding surface is directed toward the end portion of the paper mounting base 2. A dust tray 25 is attached to an end portion of the paper mounting base 2 below the fixed blade 5. Arrangement structures of the fixed blade 5, the guide rail 4 and the dust tray 25 with respect to the paper mounting base 2 are shown in detail in FIG. 3 in which the supporting member 13a is omitted.

The supporting members 13a, 13b are mounted on both side edges of the paper mounting base 2 and the cover 14 is attached to the end surfaces of the respective supporting members 13a, 13b. A supporting shaft 30 is formed at an end portion of each of the supporting members 13a, 13b on an opposite side of the fixed blade 5 and inserted into a rotation hole 31 formed in an end portion of the auxiliary paper mounting base 22 disposed on the rear surface of the paper mounting base 2 and accommodated in the paper mounting base freely. FIGS. 3 and 4 in which one of the right and left supporting members 13a, 13b and the corresponding cover 14 on one side are omitted show a condition in which the auxiliary paper mounting base 22 is accommodated in the paper mounting base 2.

As a consequence, the auxiliary paper mounting base 22 can be developed by rotation (condition indicated in FIG. 8B) and accommodated by rotation (condition indicated in FIG. 1) with respect to the paper mounting base 2 as shown in FIGS. 8A and 8B. As shown in FIG. 8B, an engaging piece 22a and a flange portion 22b are formed on a rear surface of the auxiliary paper mounting base 22. By engaging this engaging piece with an engaging piece (not shown) formed on the rear surface of the paper mounting base 2, the auxiliary paper mounting base 22 can be accommodated in and fixed to the paper mounting base 2.

By pressing the flange portion 22b exposed through a cutout 13c formed in each of the supporting members 13a, 13b with the auxiliary paper mounting base 22 accommodated within the paper mounting base 2, engagement between the engaging piece 22a and the engaging piece formed on the rear surface of the paper mounting base 2 can be released.

As shown in FIG. 2, the slider 8 is disposed slidably in a groove of the guide rail 4. Particularly, as shown in FIGS. 2, 4 and 5, a mounting portion 7a of a rotary blade holder 7 and an arm 9 are attached to the slider 8 with a screw or the like.

That is, the arm 9 strides over the cutting edge of the fixed blade 5 and is connected to the slider 8 disposed on the rear surface of the cutting edge of the fixed blade 5 while the rotary blade holder 7 strides over the fixed blade 5 independently of the arm 9 and is connected to the slider 8 disposed on the rear surface of the fixed blade 5.

The rotary circular blade 6 is supported in the rotary blade holder 7 so as to be rotatable with its blade surface being in contact with the cutting edge of the fixed blade 5. A rotation shaft of the rotary circular blade 6 is disposed above a top surface of the fixed blade 5. As a consequence, when cutting a paper sheet, the rotary circular blade can cut down the paper nipped between the fixed blade and the paper pressing holder 10.

The arm 9 is provided with the paper pressing plate pressing portion 15 at an end portion opposite to a slider attaching side for pressing the paper pressing plate 10. As shown in FIG. 2, the paper pressing plate pressing portion 15 is formed within an upper cover 20a attached to the arm 9, including a pressing roller 16, a roller holder 16a supporting the pressing roller rotatably, and a leaf spring 17 for urging the roller holder 16a to the paper pressing plate 10. The roller holder 16a is attached to the arm 9 through the leaf spring 17. Because the slider is equipped with the rotary blade holder and the arm separately, by forming the arm of metallic material, strength of the arm which allows the slider to slide can be improved. The upper cover 20a covers the arm 9 and the rotary blade holder 7 from above while a lower cover covers attaching portions of the arm 9 with respect to the slider 8 and the rotary blade holder 7 from beneath.

The rotary blade holder 7 is accommodated within a pair of upper and lower covers 20a, 20b. As shown in FIG. 5, a pressing position on the paper pressing plate 10 by the pressing roller 16 is set in a cutting direction of the rotary circular blade 6 before a cutting position by the rotary circular blade 6 and the fixed blade 5. As a consequence, with the paper pressing plate pressed before the cutting position, a paper sheet to be cut can be cut by the rotary circular blade 6 and the fixed blade 6, thereby securely preventing the paper sheet to be cut from deflecting.

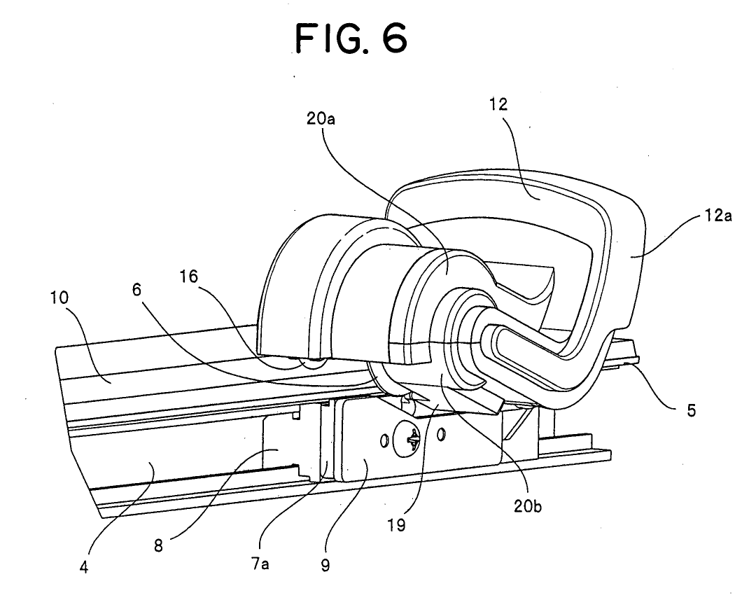

An inclined portion 19 for letting out a cut piece cut by the rotary circular blade 6 is formed on a portion of the lower cover 20b which strides over the fixed blade 5 as shown in FIG. 6. The cut piece cut by the rotary circular blade 6 and the fixed blade 5 is discharged downward along an inclined surface of the inclined portion 19 and stored into the dust tray 25 (see FIG. 3) disposed below the guide rail 4.

A grip 12 is formed on the upper cover 20a. A rubber portion 12a for improving a tactile feeling of a hand which operates the grip 12 with a pressure is disposed on a peripheral portion of the grip 12.

By moving the grip 12 horizontally, the pair of the upper and lower covers 20a, 20b or the like can be slid along the guide rail 4 while a constant load spring 27 is being pulled out as shown in FIG. 4. At this time, a paper sheet to be cut nipped between the fixed blade 5 and the paper pressing plate 10 can be cut by means of the rotary circular blade 6 and the fixed blade 5.

The slider 8 is connected to the constant load spring 27, which urges the slider 8 so that the rotary circular blade 6 returns to an initial position side where cutting starts. The constant load spring 27 is supported by a constant load spring holder 28 through a pin 29 and the constant load spring holder 28 is disposed at the supporting member 13b.

When cutting of the paper sheet to be cut ends, the pair of the upper and lower covers 20a, 20b can be automatically returned to a cutting startup position by the constant load spring 27 if the grip 12 is released. The pair of the upper and lower covers 20a, 20b slides in the cutting direction under a pressure resisting a pulling force of the constant load spring 27 connected to the slider 8 and the pulling force of the constant load spring 27 is always a constant pulling force regardless of a sliding amount of the pair of the upper and lower covers 20a, 20b in the cutting direction.

Thus, in a paper cutter having a wide cutting width also, the pair of the upper and lower covers 20a, 20b can be always slid in the cutting direction by a constant, light pressing force without increase of the pulling force as the moving amount in the cutting direction increases. In case where the pair of the upper and lower covers 20a, 20b is automatically returned to the cutting startup position by the pulling force of the constant load spring 27, the pair of the upper and lower covers 20a, 20b can be returned at a constant speed without being returned rapidly.

The present invention can be applied to an apparatus having a same structure as the paper cutter.

What is claimed is:

1. A paper cutter comprising:
a paper mounting base;
a long linear fixed blade disposed at an end of the paper mounting base with its front surface substantially flush with a top surface of the paper mounting base and its rear surface being provided with a guide rail;
a slider which slides along the guide rail;
a rotary circular blade which slides in contact with the fixed blade with its rotation shaft disposed above a front surface of the fixed blade;
a rotary blade holder which rotatably supports the rotary circular blade;
an arm attached to the slider such that it strides over a cutting edge of the fixed blade; and
a manual operating portion provided on the arm, wherein
the rotary blade holder is attached to the slider such that it strides over the cutting edge of the fixed blade and by pressing the manual operating portion in a horizontal direction, the rotary circular blade is slid along the fixed blade in contact with the fixed blade.

2. The paper cutter according to claim 1, further comprising:
a long paper pressing plate disposed substantially in parallel to a longitudinal direction of the fixed blade such that it is capable of approaching and leaving the front surface of the fixed blade; and
a paper pressing plate pressing portion provided on the arm for pressing the paper pressing plate in a direction of the fixed blade, wherein
a paper sheet to be cut mounted on the paper mounting base is nipped by the paper pressing plate and the fixed blade and
a pressing member of the paper pressing plate pressing portion for pressing the paper pressing plate in the direction of the fixed blade is disposed in a sliding direction of the rotary circular blade before a cutting position by the rotary circular blade and the fixed blade when the rotary circular blade is slid in a cutting direction.

3. The paper cutter according to claim 2, wherein the pressing member is a pressing roller.

4. The paper cutter according to claim 3, wherein the pressing roller is urged by a leaf spring toward the paper pressing plate.

5. The paper cutter according to claim 1, wherein the manual operating portion is a grip formed on the paper pressing plate pressing portion.

6. The paper cutter according to claim 1, wherein an inclined portion for guiding a cut piece cut by the rotary circular blade and the fixed blade outward is formed in a part of the arm.

7. The paper cutter according to claim 1, wherein the paper mounting base has an auxiliary paper mounting base, and the auxiliary paper mounting base is accommodated in the paper mounting base when the auxiliary paper mounting base is not used.

8. The paper cutter according to claim 1, wherein a dust tray is formed below the guide rail.

9. The paper cutter according to claim 1, wherein the paper mounting base is provided with a guide piece for restricting a position of an edge of one side of the paper sheet to be cut and the guide piece is constructed so as to be changeable between a fixed state and a released state with respect to the paper mounting base, and in the released state, the guide piece is capable of adjusting a restricting direction with respect to the position of the edge of one side of the paper sheet to be cut.

10. The paper cutter according to claim 1, wherein the slider is connected to a constant load spring provided on one side of the guide rail while the slider is urged to return to a direction opposite to a cutting direction of the rotary circular blade by the constant load spring.

11. The paper cutter according to claim 1, wherein the paper pressing plate is formed of a transparent plate and a plurality of scales are formed in parallel to a cutting line of the fixed blade on the paper pressing plate.

12. The paper cutter according to claim 2, wherein the manual operating portion is a grip formed on the paper pressing plate pressing portion.

13. The paper cutter according to claim 2, wherein an inclined portion for guiding a cut piece cut by the rotary circular blade and the fixed blade outward is formed in a part of the arm.

14. The paper cutter according to claim 2, wherein the paper mounting base has an auxiliary paper mounting base, and the auxiliary paper mounting base is accommodated in the paper mounting base when the auxiliary paper mounting base is not used.

15. The paper cutter according to claim 2, wherein a dust tray is formed below the guide rail.

16. The paper cutter according to claim 2, wherein the paper mounting base is provided with a guide piece for restricting a position of an edge of one side of the paper sheet to be cut and the guide piece is constructed so as to be changeable between a fixed state and a released state with respect to the paper mounting base, and in the released state, the guide piece is capable of adjusting a restricting direction with respect to the position of the edge of one side of the paper sheet to be cut.

17. The paper cutter according to claim 2, wherein the slider is connected to a constant load spring provided on one side of the guide rail while the slider is urged to return to a direction opposite to a cutting direction of the rotary circular blade by the constant load spring.

18. The paper cutter according to claim 2, wherein the paper pressing plate is formed of a transparent plate and a plurality of scales are formed in parallel to a cutting line of the fixed blade on the paper pressing plate.
